(19) United States
(12) Patent Application Publication
(10) Pub. No.: US 2025/0035902 A1
(43) Pub. Date: Jan. 30, 2025

(54) OPTICAL ANCILLARY DEVICE ATTACHED TO MICROSCOPE AND MICROSCOPE ASSEMBLY INCLUDING THE SAME

(71) Applicant: Carl Zeiss Meditec AG, Jena (DE)

(72) Inventors: Jamie Ren, Shanghai (CN); Artur Hoegele, Oberkochen (DE); Carol Zhang, Shanghai (CN); Terry Ji, Shanghai (CN); Rui Zhu, Bengbu (CN)

(21) Appl. No.: 18/781,639

(22) Filed: Jul. 23, 2024

(30) Foreign Application Priority Data
Jul. 24, 2023 (CN) 202310914779.7

(51) Int. Cl. G02B 21/08; G02B 21/00; G02B 21/02

(52) U.S. Cl. CPC G02B 21/08; G02B 21/0012; G02B 21/02

(57) ABSTRACT

An optical ancillary device is configured to be attached to a microscope. The optical ancillary device includes an imaging optical device configured to be placed in an imaging beam path of the microscope and an illumination optical device adapted to be placed in an illumination beam path of the microscope. The imaging beam path and the illumination beam path are separated. The illumination optical device is configured to match the imaging optical device, thereby acting on the illumination beam path to cast light into a field of view of the microscope. The illumination optical device of the optical ancillary device matches the imaging optical device, so that the illumination is adapted to the changed observed area, that is, the adjusted field of view of the microscope, so as to ensure the illumination quality of the changed observed area.

### CROSS-REFERENCE TO RELATED APPLICATIONS

This application claims priority of Chinese patent application no. 202310914779.7, filed Jul. 24, 2023, the entire content of which is incorporated herein by reference.

### TECHNICAL FIELD

The present disclosure relates to the technical field of an optical microscope, in particular to an optical ancillary device adapted to be attached to an optical microscope and a microscope assembly including a microscope and the optical ancillary device.

### BACKGROUND

A microscope usually includes an imaging beam path and an illumination beam path. A microscope has the ability to adapt the imaging beam path to observe different areas or different objects clearly with a variable resolution and at a variable distance. Microscopes are built to be able to vary these parameters within a distinct range. Extending and/or changing this distinct range allow for a more flexible and versatile usage of the microscope.

Illumination beam path(s) are typically overlaid with the imaging beam path so as to optimize the guidance of light to an observed area. In the prior art, ancillary devices have been built to be attached to a microscope. However, these ancillary devices are built to work on a single optical beam path in order to act primarily on the imaging beam path and only secondarily act on the illumination beam path. There are also other microscope configurations which are different with respect to the placement and orientation of the illumination and can even include several illumination devices. Therefore, when changing the resolution of the microscope with the ancillary devices, the illumination may also get changed and may result in inferior illumination of or even cast shadows on the observed area.

### SUMMARY

It is an object of the present disclosure to address at least one of the aforementioned problems and defects in the prior art, as well as other technical problems.

In an aspect of the present disclosure, there is provided an optical ancillary device adapted to be attached to a microscope. The optical ancillary device includes: an imaging optical device adapted to be placed in an imaging beam path of the microscope; and an illumination optical device adapted to be placed in an illumination beam path of the microscope, wherein the imaging beam path and the illumination beam path are separated, and wherein the illumination optical device is configured to match the imaging optical device, thereby acting on the illumination beam path to cast light into a field of view of the microscope.

In this technical solution, the imaging beam path and the illumination beam path are separated and the illumination optical device of the optical ancillary device matches the imaging optical device, so that the illumination is adapted to the changed observed area, that is, the adjusted field of view of the microscope, so as to ensure sufficient illumination of the changed observed area.

According to an embodiment, the illumination optical device is configured to deflect the illumination beam path to cast light into the field of view of the microscope.

According to an embodiment, the illumination optical device includes at least one pair of mirrors.

According to an embodiment, the illumination optical device includes at least one prism.

In the above two examples, the illumination beam path can be changed via a simple structure, casting light into the field of view of the observed object, and changing the microscope resolution with sufficient illumination.

According to an embodiment, the microscope includes a housing, and the optical ancillary device is adapted to be detachably attached to the housing.

According to an embodiment, the optical ancillary device includes: a fixing member adapted to be fixed to the housing; a body having an optical body portion and a connecting portion, wherein the illumination optical device and the imaging optical device are arranged in the optical body portion, and the connecting portion is detachably connected to the fixing member.

In this embodiment, the connecting portion is detachably connected to the fixing member fixed to the microscope, thus in an ordinary state, only the fixing member is fixed to the housing, while the body can be removed from the fixing member. The connecting portion of the body can be reconnected to the fixing member when necessary. The structure enables the body to be removed when not in use for avoiding dust.

According to an embodiment, the optical body portion is fixedly connected to the connecting portion, and is configured such that when the connecting portion is fixed in position on the fixing member, the illumination optical device and the imaging optical device are respectively placed in the illumination beam path and the imaging beam path. Such a configuration ensures the positioning accuracy of the optical body portion, especially the illumination optical device and imaging optical device therein, with respect to the microscope.

According to an embodiment, the optical body portion and the connecting portion are connected in a relatively slidable manner, so that the optical body portion is slidable with respect to the microscope, moving the illumination optical device and the imaging optical device into or out of the illumination beam path and the imaging beam path, respectively. Such a configuration enables the optical body portion of the optical ancillary device to be moved in and out quickly as needed, without removing the body of the optical ancillary device when not in use, which is convenient for an operator.

According to an embodiment, the fixing member is configured as a receptacle, which includes a first wall adapted to be connected to the housing and a second wall opposite to the first wall, wherein the connecting portion is adapted to be inserted between the first wall and the second wall. Such a configuration allows precise positioning of the connecting portion of the body with respect to the receptacle.

According to an embodiment, the optical ancillary device further includes a positioning member, which passes through the second wall and the connecting portion, and is then fastened to the first wall, in particular screwed into a threaded hole formed in the first wall. The positioning member in this embodiment can be used to fasten the connecting portion in a direction perpendicular to the insertion direction of the connecting portion, thus ensuring the positioning accuracy of the connecting portion in the receptacle.

According to an embodiment, the receptacle is further provided with a locking hole extending from an outer surface of the receptacle to an internal space of the receptacle and a locking component passing through the locking hole; and an insertion end of the connecting portion is provided with a locking cooperation portion, the locking component being adapted to cooperate with the locking cooperation portion to lock or release the connecting portion.

According to an embodiment, the locking component includes: a spring bearing against a spring seat formed on the receptacle; and a locking member interacting with the spring and adapted to be pressed to be slidable with respect to the receptacle; wherein the locking member is formed with a stop member, and the locking cooperation portion is formed with a stop surface cooperating with the stop member.

According to an embodiment, the locking cooperation portion is further formed with a guiding surface, via which the stop member can be guided into engagement with the stop surface during an insertion of the connecting portion into the receptacle.

In the above embodiments, the locking component is provided to achieve a primary connection and positioning of the connecting portion in the receptacle upon insertion of the connecting portion into the receptacle, and the connection can be easily released by simply pressing the locking member.

According to an embodiment, the optical ancillary device includes an electrical connection interface electrically connected to the microscope. The electrical connection interface enables information and/or power exchange between the microscope and the optical ancillary device. The information includes, for example, the type of optical ancillary device, the parameters or settings of the optical ancillary device, the type of the microscope, the setting of the imaging beam path and/or the illumination beam path, and the settings of an illumination source, and so on.

According to an embodiment, the optical ancillary device further includes a control device which is electrically connected to the microscope via the electrical connection interface. Such a structure facilitates an automatic control of the microscope assembly, especially for a microscope using a varioscope and an optical ancillary device using a varioscope, since exchanging of the current setting information of the microscope or the optical ancillary device facilitates controlling of the varioscope accordingly.

According to an embodiment, the optical ancillary device includes a control device and can communicate wirelessly with the microscope. The control device is for example a chip, on which a wireless communication module is integrated. The wireless communication facilitates exchange of information and simplifies the mechanical structure of the microscope.

According to an embodiment, the optical ancillary device further includes a sensor provided on the receptacle or the connecting portion and arranged to send a signal when the connecting portion is inserted in place in the receptacle. The embodiment enables informing of the state in which the optical body portion of the optical ancillary device is in position in the optical beam path of the microscope, and the optical ancillary device is ready.

According to an embodiment, the sensor is arranged inside the receptacle, and the receptacle is provided with an electrical connection interface electrically connecting the sensor to the microscope.

According to an embodiment, the sensor is a touching switch.

According to an embodiment, the optical ancillary device includes a fixing member adapted to be fixed to the housing and an optical body portion slidably connected to the fixing member and capable of sliding into and out of a working position, wherein the illumination optical device and the imaging optical device are arranged in the optical body portion and are respectively placed in the illumination beam path and the imaging beam path when the optical body portion is in the working position.

In this technical solution, in the ordinary state, the optical body portion is suspended, through the fixing member, in a rest position out of the illumination optical path and imaging optical path. Such a configuration in this example enables the optical body portion of the optical ancillary device to be moved in and out quickly as needed, which greatly facilitates the operator.

According to an embodiment, the optical ancillary device further includes a sensor that sends out a signal when the optical body portion slides into the working position.

According to an embodiment, the optical ancillary device further includes an electrical connection interface electrically connect the optical body portion to the microscope, so as to exchange information and/or power between the microscope and the optical body portion.

In another aspect of the present disclosure, there is also provided a microscope assembly including a microscope and at least one optical ancillary device in any of the above embodiments. According to the disclosure, a plurality of optical ancillary devices may be provided, constituting a kit, so as to provide a series of resolution options, which allows an operator to choose different optical ancillary devices as needed.

According to an embodiment, a protrusion is formed on the housing of the microscope, and a recess is formed in the optical ancillary device, a peripheral edge of the protrusion abutting against a peripheral edge of the recess to locate the optical ancillary device with respect to the microscope. In this embodiment, the peripheral edge of the protrusion abuts against the peripheral edge of the recess to accurately locate the receptacle with respect to the microscope, thereby accurately locating the optical ancillary device.

According to an embodiment, the microscope includes a varioscope, thus more magnification factors can be achieved. Furthermore, by adding the optical ancillary device of the present disclosure to such a microscope, a wider range of magnification factors can be obtained.

According to an embodiment, the imaging optical device and/or the illumination optical device is configured as a varioscope. The configuration brings a larger range of magnification factors and a versatile usage for the microscope.

### BRIEF DESCRIPTION OF DRAWINGS

The invention will now be described with reference to the drawings wherein:

FIGS. 1A, 1B, and 1C schematically show acting of an optical ancillary device in principle, in which FIG. 1A shows a beam path of a microscope without an optical ancillary device, FIG. 1B shows the acting on the beam path when an optical ancillary device is provided, and FIG. 1C shows the beam path after removing the optical ancillary device;

FIG. 2 shows a schematic view of a beam path when an optical ancillary device is applied, in which an illumination optical device of the optical ancillary device includes a pair of mirrors;

FIG. 3 shows a schematic view of a beam path when an optical ancillary device according to another embodiment is applied, wherein the illumination optical device of the optical ancillary device includes a pair of prisms;

FIG. 4 shows a schematic view of a microscope assembly according to an embodiment of the present disclosure, in which the optical ancillary device is attached to the microscope and shown in a partial cross-sectional view, and the microscope and an optical body portion of the optical ancillary device are schematically shown as rectangular frames;

FIG. 5 schematically shows a front view of the optical ancillary device, in which the optical body portion is schematically shown as a rectangular frame;

FIG. 6 schematically shows a top view of the optical ancillary device, in which a cover above a sensor is removed so that the sensor can be seen;

FIG. 7 schematically shows a perspective view of a connecting portion of the optical ancillary device, in which a locking cooperation portion can be seen;

FIG. 8 schematically shows a cross-sectional view of the optical ancillary device in FIG. 5 taken along a line L1-L1; and,

FIG. 9 schematically shows a perspective view of a receptacle.

### DETAILED DESCRIPTION

In the detailed description below, many specific details are elaborated for a comprehensive understanding of the embodiments. However, it is evident that one or more embodiments can also be implemented without these specific details.

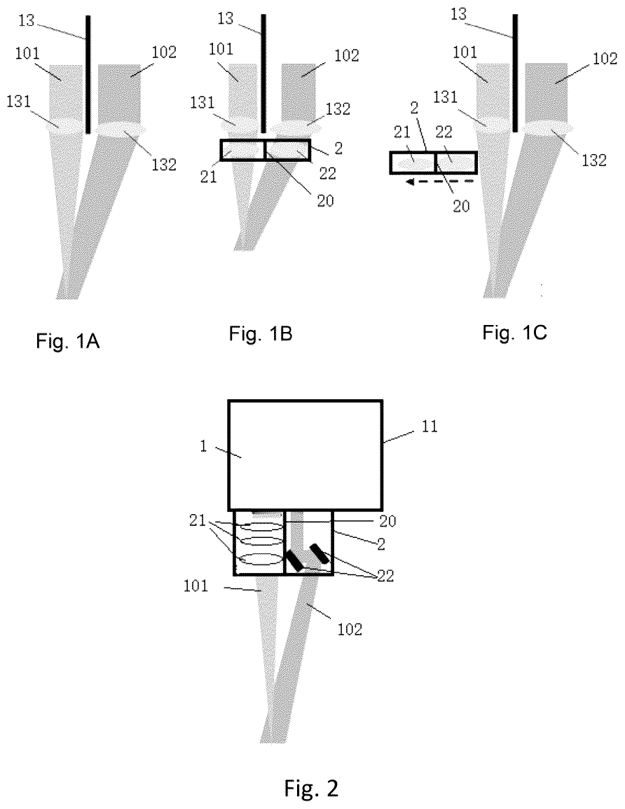

FIG. 1A shows a beam path of a microscope without an optical ancillary device 2. FIG. 1B shows a beam path when an optical ancillary device 2 is provided. FIG. 1C shows the beam path after removing the optical ancillary device 2. FIGS. 1A to 1C schematically show an illumination beam path 102 and an imaging beam path 101 of the microscope, with the imaging optical device 131 (or called imaging lens) of the microscope being placed in the imaging beam path 101, and the illumination beam device 132 (or called illumination lens) of the microscope being placed in the illumination path 102.

For facilitating adjustment of the resolution of the microscope, according to an embodiment of the present disclosure, as shown in FIG. 1B, there is provided an optical ancillary device 2 adapted to be attached to the microscope 1. The optical ancillary device 2 includes an imaging optical device 21 adapted to be placed in the imaging beam path 101 of the microscope, and an illumination optical device 22 adapted to be placed in the illumination beam path 102 of the microscope. The imaging beam path 101 and illumination beam path 102 are distinct and separated. The imaging optical device 21 does not act on the illumination beam path and the illumination optical device 22 does not act on the imaging beam path either. Such a separated illumination mode is shown in FIGS. 1A to 1C, that is, the illumination optical path is isolated from the imaging optical path, by a partition 13 and a partition 20 schematically shown in these figures. Mutual interference between the imaging beam path and the illumination beam path and reflection can be avoided in this mode. The illumination optical device 22 is configured to match the imaging optical device 21, thereby acting on the illumination beam path to cast light into a field of view of the microscope, as shown in FIG. 1B.

The technical term “match” between the illumination optical device and the imaging optical device herein means that the illumination optical device 22 mates with the imaging optical device 21, such that the changed illumination spot (the range that the illumination beam covers the object plane) at least covers the whole field of view of the changed imaging beam path 101 on the object place. In other words, the illumination light at least illuminates the whole field of view of the microscope formed after the resolution is changed.

The imaging beam path 101 and the illumination beam path 102 are separated, in which the imaging optical device 21 of the optical ancillary device 2 provides a focus change, and the illumination optical device 22 matches the imaging optical device 21, so that the illumination is adapted to the changed observed area, that is, the adjusted field of view of the microscope, so as to ensure the sufficient illumination of the changed observed area. Moreover, the resolution of the microscope is changed by attaching the optical ancillary device 2 to the microscope 1, with the imaging optical device 21 and illumination optical device 22 of the optical ancillary device 2 respectively placed in the imaging beam path and illumination beam path to change the resolution, thus the defect of time-consuming and labor-intensive replacement of the imaging optical assembly and/or illumination optical assembly of the microscope in the prior art is avoided.

It should also be pointed out that although the imaging optical device 131 and the illumination optical device 132 of the microscope as well as the imaging optical device 21 and the illumination optical device 22 of the optical ancillary device 2 are all shown as lenses in FIGS. 1A to 1C, they in fact can be implemented in various forms, that is, they can be configured as a single optical element or a combination of multiple optical elements of any suitable type.

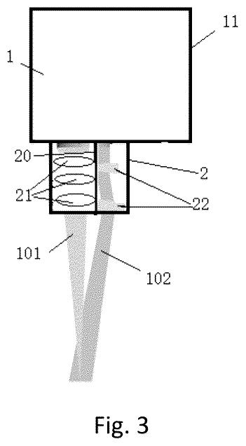

As shown in FIGS. 2 and 3, the illumination optical device 22 is configured to deflect the illumination beam path of the microscope such that light can be casted into the field of view of the microscope.

FIG. 2 schematically shows an optical ancillary device 2 attached to the microscope 1, which includes a housing 11. The optical ancillary device 2 is adapted to be detachably attached to the housing 11. In this way, the optical ancillary device 2 can be easily removed or attached as needed. The specific structure will be described in detail below.

As shown in FIG. 2, the illumination optical device 22 of the optical ancillary device 2 may include one pair of mirrors, which reflect light from the illumination beam path 102 of the microscope, deflect the illumination beam path 102, and cast the light into the field of view of the changed imaging beam path on the object plane.

FIG. 3 schematically shows an optical ancillary device, according to another embodiment, attached to the microscope 1. In contrast to FIG. 2, the illumination optical device 22 of the optical ancillary device 2 in FIG. 3 is embodied as a pair of prisms, which changes the direction of the illumination beam path and casts light into the changed field of view. Using prisms instead of mirrors can reduce adjustment for the illumination optical device and save space. Furthermore, the accuracy in guiding the illumination beam can be increased and fewer optical elements may be required.

In the technical solutions as shown in FIGS. 2 and 3, the illumination beam path is changed by a pair of prisms or a pair of mirrors, and the position of the illumination spot is changed so as to correspond to the whole field of view of the microscope formed after the resolution is changed.

In the above two examples and the corresponding FIGS. 2 and 3, the illumination optical device 22 of the optical ancillary device 2 is described by taking a pair of mirrors or a pair of prisms as an example. However, it should be noted that the illumination optical device 22 of the optical ancillary device 2 may be otherwise composed, for example, it may include one or more mirrors, prisms, lenses or combinations thereof, as long as the illumination optical device matches the focal distance of imaging optical device 21 of the optical ancillary device 2 and light is cast into the changed field of view of the microscope for at least illuminating the whole changed field of view.

The present disclosure further provides a microscope assembly, which may include a microscope and one or more optical ancillary devices, wherein each of the optical ancillary devices may include imaging optical devices with different constitutions or functions, as well as a matching illumination optical device, thereby achieving multiple resolutions when combined with the microscope. By way of example, multiple optical ancillary devices may constitute a kit to provide a series of resolution options, and operators can select different optical ancillary devices according to their needs.

The microscope in the present application may include a varioscope, thus more magnification factors can be achieved. Moreover, by adding the optical ancillary device according to the present disclosure to such a microscope, a wider range of magnification factors can be obtained as a whole. The optical ancillary device of the present disclosure is applicable to at least a part of a range of magnification factors of the microscope, preferably applicable to the whole range of magnification factors, i.e, all the magnification factors of the microscope. In other words, the optical ancillary device is adapted to provide a focus change and corresponding illumination change for all optical parameter settings of the microscope.

Furthermore, the imaging optical device may be configured as a varioscope, or a fixed-focus lens. The illumination optical device may be configured as a varioscope or a fixed-focus lens. When the optical ancillary device adopts varioscope(s), a larger range of magnification factors and a versatile usage of the microscope can be obtained.

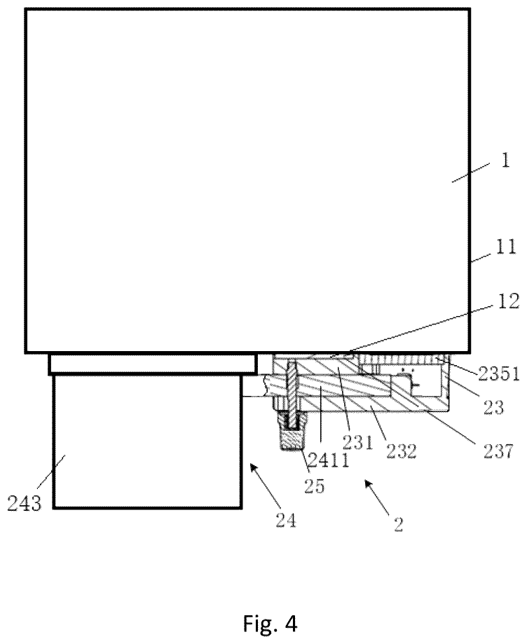

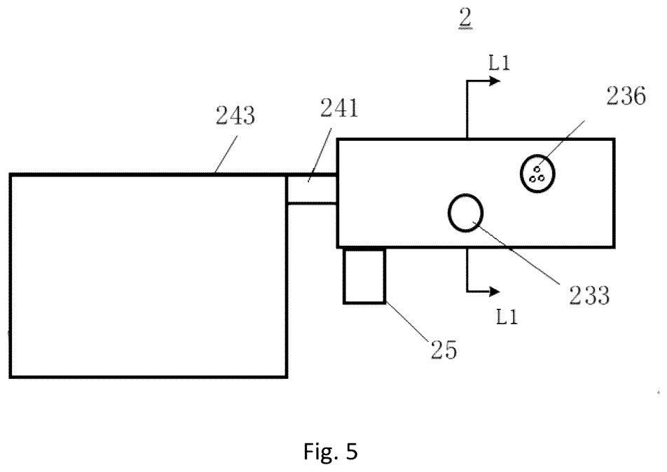

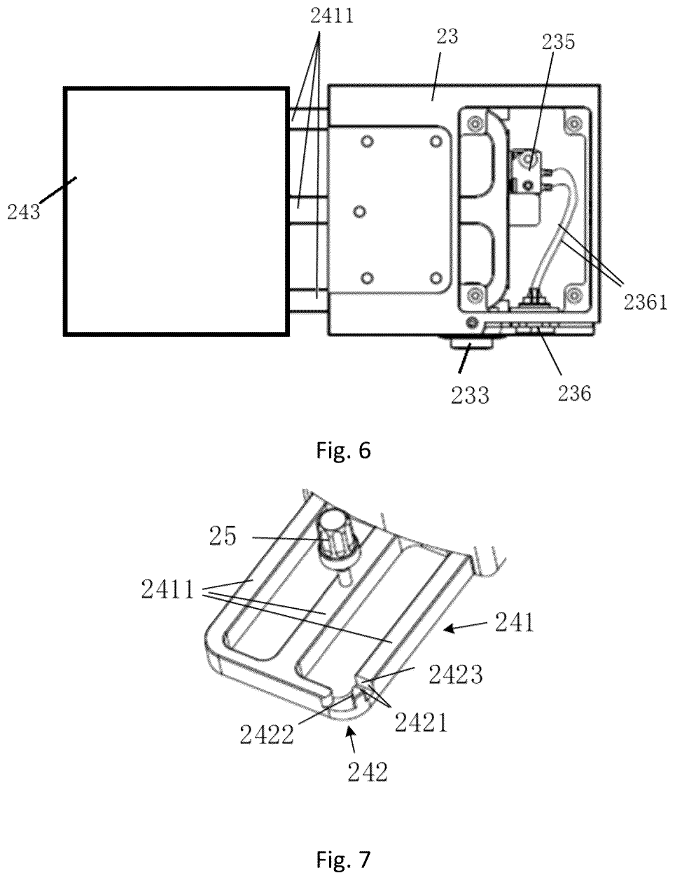

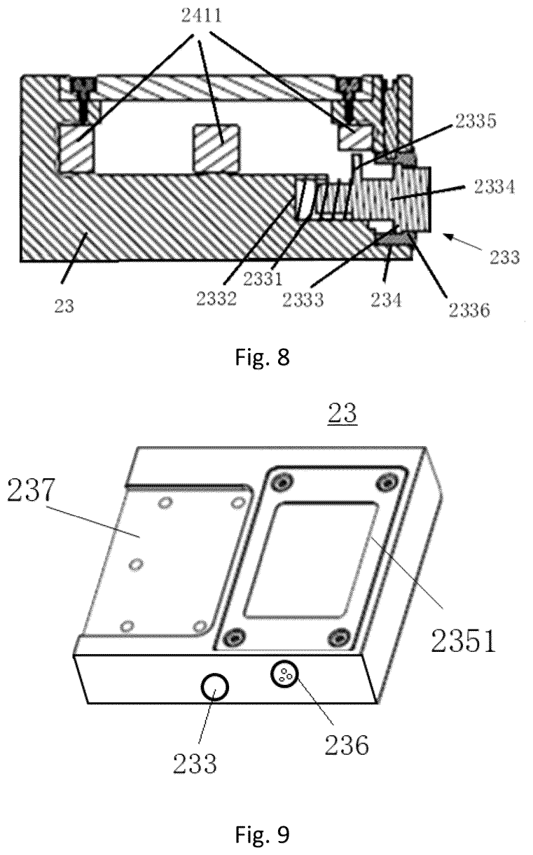

FIG. 4 shows a schematic view of a microscope assembly, in which the optical ancillary device 2 is attached to the microscope 1 and shown in a partial cross-sectional view, and the microscope 1 and the optical body portion of the optical ancillary device 2 are schematically shown as rectangular frames. FIG. 5 schematically shows a front view of the optical ancillary device2, in which the optical body portion is schematically shown as a rectangular frame. FIG. 6 schematically shows a top view of the optical ancillary device 2, in which a cover above a sensor is removed so that the sensor can be seen. FIG. 7 schematically shows a perspective view of a connecting portion of the optical ancillary device 2, in which a locking cooperation portion 242 can be seen. FIG. 8 schematically shows a cross-sectional view of the optical ancillary device 2 in FIG. 5 taken along a line L1-L1, in which a locking component 233 is clearly shown. FIG. 9 schematically shows a perspective view of a receptacle.

As shown in FIGS. 4 to 9, as a specific exemplary structure for detachably attaching the optical ancillary device 2 to the housing 11, the optical ancillary device 2 includes a fixing member, for example, in the form of a receptacle 23. The fixing member is adapted to be fixed to the housing 11 of microscope 1. The optical ancillary device 2 further includes a body 24, which includes an optical body portion 243 and a connecting portion 241. The illumination optical device 22 and imaging optical device 21 are arranged in the optical body portion 243, and the connecting portion 241 is adapted to be detachably attached to the fixing member. The illumination optical device and the imaging optical device are not shown in FIGS. 4 to 6, since the microscope 1 and the optical body portion 243 are schematically shown as rectangular frames for simplifying these figures.

In this example, the connecting portion 241 is detachably connected to the fixing member fixed to the microscope, thus in an ordinary state, only the fixing member is fixed to the housing 11, while the body 24 can be removed from the fixing member. The connecting portion 241 of the body 24 can be reconnected to the fixing member when necessary.

As can be seen in FIGS. 4 to 9, as an example, the fixing member may take the form of the receptacle 23. The receptacle 23 includes a first wall 231 adapted to be connected to the housing 11 and a second wall 232 opposite to the first wall 231. The connecting portion 241 of the body 24 is adapted to be inserted between the first wall 231 and the second wall 232. Such a configuration allows precise positioning of the connecting portion 241 of the body 24 with respect to the receptacle 23. As an example, the connecting portion 241 includes three parallel rod-shaped members 2411, which slide into the receptacle 23 and are fixed by the locking component 233 and a positioning member 25 to be described in detail below. As shown in FIG. 8, the three rod-shaped members 2411 may be arranged such that two side rod-shaped members 2411 abut against the inner wall of the receptacle 23 at their upper, lower, and outer side surfaces respectively, so as to avoid oscillating. Those skilled in the art can understand that such structures of the receptacle 23 and the connecting portion 241 which is inserted into the receptacle 23 are only exemplary, and other connecting structures are also applicable, as long as the body 24 can be detachably connected to the fixing member.

As an example, the optical body portion 243 of the body 24 can be fixedly connected to the connecting portion 241 via, for example, threaded fasteners (not shown). When the connecting portion 241 is fixed in place in the receptacle 23, the illumination optical device and the imaging optical device in the optical body portion 243 are respectively placed in the illumination optical path and the imaging optical path.

For positioning the connecting portion 241 in the receptacle 23, as an example, the present disclosure provides such a technical solution that, as shown in FIGS. 7 and 8, the receptacle 23 is provided with a locking hole 234 extending from its outer surface to its internal space, and a locking component 233 passing through the locking hole 234. An insertion end of the connecting portion 241 is provided with a locking cooperation portion 242, the locking component 233 being adapted to cooperate with the locking cooperation portion 242 to lock or release the connecting portion 241. As a specific example, the locking component 233 may include a spring 2331 bearing against a spring seat 2332 formed in the receptacle 23, and a locking member 2334 interacting with the spring 2331 and adapted to be pressed to slide with respect to the receptacle 23 (the locking member may be a button). The locking member 2334 is formed with a stop member 2335 adapted to cooperate with stop surfaces 2421 formed on the locking cooperation portion 242 as shown in FIG. 7. The spring 2331 biases the locking member 2334 towards the outer side of the receptacle 23. Under the bias of the spring 2331, the locking member 2334 is positioned with its step portion 2333 abutting against a sleeve 2336. In this position, the stop member 2335 cooperating with the stop surfaces 2421 holds the connection portion 241 in position with respect to the receptacle 23. Preferably, a guiding surface 2422 can be formed on the locking cooperation portion 242. During the pushing of the connecting portion 241 of the body 24 into the receptacle 23, the guiding surface 2422 contacts the stop member 2335 on the locking member 2334. The stop member 2335 enters a groove 2423 under the guidance of the inclined guiding surface 2422 as shown in FIG. 7, and cooperates with two stop surfaces 2421 (two side surfaces of the groove 2423) to block the continued insertion and retraction of the connecting portion 241, thereby locking the connecting portion 241 and the whole body 24.

When releasing the connecting portion 241, the locking member 2334 is pressed and then slides towards the interior of the receptacle against the bias of the spring 2331, until the stop member 2335 is not engaged with the stop surfaces 2421 anymore and is moved out from the groove 2423, no more obstructing retraction of the connecting portion 241. Therefore, the connecting portion 241 can be pulled out to remove the body 24 from the receptacle 23.

Preferably, a sensor 235 may be arranged on the receptacle 23, so as to send a signal indicating that the connecting portion 241 has been inserted in place into the receptacle, thereby indicating the state in which the optical body portion 243 is in position in the optical beam path of the microscope and the optical ancillary device is ready. As an example, the sensor 235 can be a touching switch to which is triggered when the connecting portion 241 is inserted in place. As shown in FIG. 6, as an example, the sensor 235 is mounted inside the receptacle 23, and the receptacle 23 is provided with an electrical connection interface 236, one end of which is electrically connected to the sensor 235 via, for example, a wire 2361 shown in FIG. 6, and the other end is adapted to be electrically connected to the microscope to transmit the signal from the sensor to the microscope. It should be noted that in the top view shown in FIG. 6, in order to show the sensor 235 inside the receptacle 23, a cover 2351 (can be seen in FIG. 9) above the sensor has been removed. Moreover, those skilled in the art should understand that the position of the sensor 235 is not limited to the interior of the receptacle 23, and it may be arranged at any position on the receptacle 23 or on the connecting portion 241, or even on the housing 11 of the microscope 1.

Exemplarily, the electrical connection interface 236 can be connected to the microscope 1 through a cable (not shown). As another example, the electrical connection interface 236 may also be configured to be automatically connected to a corresponding electrical connection interface on the microscope 1 when the receptacle 23 is connected to the housing 11 of the microscope 1. Such an electrical connection interface may include an electrical contact or a spring contact, as an example.

Through the above electrical connection interface, information and power can be exchanged between the microscope 1 and the optical ancillary device. Exemplarily, the electrical connection interface can also be a wireless communication interface, and the optical ancillary device can be powered by, for example, a battery. The optical ancillary device may also include a control device (not shown) which exchanges information with the microscope via the electrical connection interface. The control device includes, for example, a memory and a processor. Through the electrical connection interface, information about the optical ancillary device, for example, the type of the optical ancillary device, the parameters, settings, et cetera, can be provided to the microscope. Alternatively and additionally, it is also possible to provide the optical ancillary device with information about the microscope, such as the type of microscope, settings of the imaging path or the illumination path, the setting of the illumination source, and the like. The structure facilitates an automatic control of the microscope assembly, especially for the microscope using the varioscope and/or the optical ancillary device using the varioscope, for which it is convenient to control the varioscope since information about the current settings of the microscope or the optical ancillary device can be exchanged through the electrical connection interface.

By way of example, as shown in FIGS. 4, 5 and 7, in order to achieve the accurate positioning of the connecting portion and thus the body 24 with respect to the microscope 1, and in turn the accurate positioning of the imaging optical device and illumination optical device in the optical body portion 243 in the imaging beam path and illumination beam path of the microscope, the optical ancillary device 2 further includes a positioning member 25. The positioning member 25 passes through the second wall 232 and the connecting portion 241, and is then fastened to the first wall 231. Specifically, as shown in FIGS. 4 and 5, the positioning member 25 may be a knob, the top of which is provided with external threads. The positioning member 25 passes through a hole in the middle rod-shaped member 2411 of the connecting portion 241, and the external threads at the top end thereof is screwed into an internal thread hole in the first wall 231 of the receptacle 23, so as to accurately position the connecting portion 241 in the insertion direction. The positioning member 25 is provided such that the connecting portion 241 can be fixed in a direction perpendicular to the insertion direction of the connecting portion 241, in addition to the connection between the locking member 233 and the locking matching section 242, thus ensuring the positioning accuracy of the connecting portion 241 in the receptacle 23.

As shown in FIG. 4, a protrusion 12 is formed on the housing 11 of the microscope 1, and it is configured in, for example, a protruding plate-like structure. A recess 237 is formed on the receptacle 23 of the optical ancillary device 2. A peripheral edge of the protrusion 12 abuts against a peripheral edge of the recess 237 so as to accurately locate the receptacle 23 with respect to the microscope 1, thereby accurately locating the optical ancillary device 2. The receptacle 23 is fixed to the housing 11 by a fastener such as a screw passing through a hole formed in the recess, or by other means.

As an alternative embodiment, the optical body portion of the optical ancillary device is slidable relative to the microscope (this embodiment is not shown). The optical ancillary device includes a fixing member adapted to be fixed to the housing of the microscope, and the optical body portion is slidably connected to the fixing member. The fixing member may be a single fixing member, or it may take the form of a combination composed of a receptacle 23 and a connecting portion 241 as shown in the embodiment in FIGS. 4 to 9.

The slidable connection between the optical body portion and the fixing member can be achieved by providing groove(s) in the optical body portion in which the fixing member slides. The groove(s) may be formed inside the optical body portion or on its outer side wall. In this way, after the fixing member is fixedly connected to the housing of the microscope, the optical body portion is slidable with respect to the fixing member and then with respect to the microscope. Therefore, when it is required to adjust the resolution of the microscope by the illumination optical device and imaging optical device of the optical ancillary device, the optical body portion can be slid so as to move the illumination optical device and imaging optical device into the illumination optical path and imaging optical path, respectively, that is, into a working position. When the optical ancillary device is not needed, the optical body portion is slid so as to move the illumination optical device and imaging optical device out of the illumination optical path and imaging optical path, respectively. In the ordinary state, the optical body portion is suspended, through the fixing member, in a rest position out of the illumination optical path and imaging optical path. Such a configuration enables the optical body portion of the optical ancillary device to be moved in and out quickly as needed, which greatly facilitates the operator.

In this embodiment in which the optical body portion of the optical ancillary device is slidable relative to the microscope, a sensor of the optical ancillary device may be arranged to be triggered when the optical body portion slides to the working position. In this configuration, the sensor may be provided on the optical body portion, the fixing member, or the housing of the microscope.

Additionally or alternatively, the sensor may also include an electrical connection interface, and a corresponding electrical connection interface is formed on the optical body portion. When the optical body portion is positioned in place, the electrical connection interface in the sensor is connected to the corresponding electrical connection interface of the optical body corresponding. In this way, the microscope can be electrically connected to the optical body portion, so that when the optical body portion is positioned in place, that is, when the imaging optical device and the illumination optical device are placed in the imaging beam path and the illumination beam path respectively, information and/or power can be exchanged between the microscope and the optical body portion.

It is understood that the foregoing description is that of the preferred embodiments of the invention and that various changes and modifications may be made thereto without departing from the spirit and scope of the invention as defined in the appended claims.

1. An optical ancillary device configured to be attached to a microscope, the optical ancillary device comprising:
an imaging optical device configured to be placed in an imaging beam path of the microscope;
an illumination optical device configured to be placed in an illumination beam path of the microscope, wherein the imaging beam path and the illumination beam path are separated; and,
said illumination optical device being further configured to match said imaging optical device thereby acting on the illumination beam path to cast light into a field of view of the microscope.

2. The optical ancillary device of claim 1, wherein said illumination optical device is configured to deflect the illumination beam path to cast light into the field of view of the microscope.

3. The optical ancillary device of claim 1, wherein said illumination optical device includes at least one pair of mirrors.

4. The optical ancillary device of claim 1, wherein said illumination optical device includes at least one prism.

5. The optical ancillary device of claim 1, wherein the microscope has a housing; and, said optical ancillary device is configured to be detachably attached to the housing.

6. The optical ancillary device of claim 5, wherein said optical ancillary device includes a fixing member adapted to be fixed to the housing and a body; said body includes an optical body portion and a connecting portion; said illumination optical device and said imaging optical device are arranged in said optical body portion; and, said connecting portion is detachably connected to said fixing member.

7. The optical ancillary device of claim 6, wherein said optical body portion is fixedly connected to said connecting portion and is configured such that when said connecting portion is fixed in position on said fixing member, said illumination optical device and said imaging optical device are respectively placed in the illumination beam path and the imaging beam path.

8. The optical ancillary device of claim 6, wherein said optical body portion and said connecting portion are connected in a slidable manner so that said optical body portion is slidable with respect to the microscope, whereby said illumination optical device and said imaging optical device are moved to move into or out of the illumination beam path and the imaging beam path, respectively.

9. The optical ancillary device of claim 6, wherein said fixing member is a receptacle having a first wall configured to be connected to the housing and a second wall opposite to said first wall; and,
said connecting portion is configured to be inserted between said first wall and said second wall.

10. The optical ancillary device of claim 9 further comprising a positioning member which passes through said second wall and said connecting portion and is then fastened to said first wall.

11. The optical ancillary device of claim 9 further comprising a positioning member which passes through said second wall and said connecting portion and is then screwed into a threaded hole formed in said first wall.

12. The optical ancillary device of claim 9, wherein said receptacle defines a locking hole extending from an outer surface of said receptacle to an internal space of said receptacle and has a locking component passing through said locking hole; wherein an insertion end of the connecting portion is provided with a locking cooperation portion; and, said locking component is adapted to cooperate with said locking cooperation portion to lock or release said connecting portion.

13. The optical ancillary device of claim 12, wherein said locking component includes:
a spring bearing against a spring seat formed in said receptacle;
a locking member interacting with said spring and configured to be pressed so as to be slidable with respect to said receptacle;
wherein said locking member is formed with a stop member; and,
said locking cooperation portion is formed with a stop surface configured to cooperate with said stop member.

14. The optical ancillary device of claim 13, wherein said locking cooperation portion is further formed with a guiding surface configured to guide said stop member into engagement with said stop surface during insertion of said connecting portion into said receptacle.

15. The optical ancillary device of claim 1 further comprising an electrical connection interface configured to electrically connect to the microscope.

16. The optical ancillary device of claim 15 further comprising a control device configured to be electrically connected to the microscope via said electrical connection interface.

17. The optical ancillary device of claim 15 further comprising a control device and the optical ancillary device is configured to communicate wirelessly with the microscope.

18. The optical ancillary device of claim 9 further comprising a sensor provided on said receptacle or said connecting portion and arranged to send a signal when the connecting portion is inserted in place in said receptacle.

19. The optical ancillary device of claim 18, wherein said sensor is arranged inside said receptacle; and, said receptacle is provided with an electrical connection interface electrically connecting said sensor to the microscope.

20. The optical ancillary device of claim 18, wherein said sensor is a touching switch.

21. The optical ancillary device of claim 5 further comprising:
a fixing member configured to be fixed to the housing; and,
an optical body portion slidably connected to the fixing member and capable of sliding into and out of a working position, wherein the illumination optical device and the imaging optical device are arranged in the optical body portion and are respectively placed in the illumination beam path and the imaging beam path in the working position.

22. The optical ancillary device of claim 21 further comprising a sensor configured to send out a signal when said optical body portion slides into said working position.

23. The optical ancillary device of claim 22 further comprising an electrical connection interface configured to electrically connect said optical body portion to the microscope.

24. The optical ancillary device of claim 1, wherein at least one of said imaging optical device and said illumination optical device is a varioscope.

25. A microscope assembly comprising:
a microscope;
an optical ancillary device configured to be attached to said microscope;
said optical ancillary device including an imaging optical device and an illumination optical device;
said imaging optical device being configured to be placed in an imaging beam path of said microscope;
said illumination optical device being configured to be placed in an illumination beam path of said microscope, wherein said imaging beam path and said illumination beam path are separated; and,
said illumination optical device being further configured to match said imaging optical device thereby acting on said illumination beam path to cast light into a field of view of said microscope.

26. The microscope assembly of claim 25, wherein the microscope assembly includes a plurality of said optical ancillary device with different optical properties.

27. The microscope assembly of claim 25, wherein a protrusion is formed on a housing of said microscope and a recess is formed in said optical ancillary device; and, a peripheral edge of said protrusion abuts against a peripheral edge of said recess to locate said optical ancillary device with respect to said microscope.

28. The microscope assembly of claim 25, wherein said microscope includes a varioscope.

29. The microscope assembly of claim 25, wherein said microscope is a surgical microscope.
